(19) United States
(12) Patent Application Publication
(10) Pub. No.: US 2026/0095877 A1
(43) Pub. Date: Apr. 2, 2026

(54) METHODS AND APPARATUS FOR DENIAL OF SERVICE (DOS) ATTACK REMEDIATION IN NON-TERRESTRIAL NETWORKS (NTN)

(71) Applicant: InterDigital Patent Holdings, Inc., Wilmington, DE (US)

(72) Inventors: Alec BRUSILOVSKY, Downington, PA (US); Michael STARSINIC, Newtown, PA (US); Michel ROY, Candiac (CA); Anuj SETHI, Ottawa (CA); Zhibi WANG, Woodridge, IL (US); Jung Je SON, Warrington, PA (US); Guanzhou WANG, Brossard (CA); Samir FERDI, Kirkland (CA)

(73) Assignee: InterDigital Patent Holdings, Inc., Wilmington, DE (US)

(21) Appl. No.: 18/903,938

(22) Filed: Oct. 1, 2024

(51) Int. Cl. H04W 60/00; H04W 12/069; H04W 84/06

(52) U.S. Cl. CPC H04W 60/00; H04W 12/069; H04W 84/06

(57) ABSTRACT

A wireless transmit and receive unit (WTRU) may be provisioned with a shared key and a WTRU identity. The WTRU may receive, from a network equipment on board the satellite, broadcasted parameters of a puzzle. The WTRU may generate evidence based on solving the puzzle and injecting the shared secret key into the evidence. The WTRU may send, to the network equipment on board the satellite, a registration request message. The registration request message may include the generated evidence and the WTRU identity. The WTRU may receive, from the network equipment on board the satellite, a registration accept responsive to the registration request.

### BACKGROUND

Non-terrestrial networks (NTNs) may facilitate deployment of wireless networks in areas where land-based antennas are impractical, for example due to geography or cost. It is envisioned that, coupled with terrestrial networks, NTNs may enable truly ubiquitous coverage of 5G networks. Initial 3GPP Rel-17 NTN deployments support basic talk and text anywhere in the world; however, it is expected that further releases coupled with proliferation of next-generation low-orbit satellites will enable enhanced services such as web browsing.

A basic NTN may include an aerial or space-borne platform which, via a gateway (GW), transports signals from a land-based based base station to a WTRU and vice-versa. Current Rel-17 NR NTNs may support, for example, power class 3 WTRUs with omnidirectional antenna(s) and linear polarization, or very small aperture antenna (VSAT) terminals with directive antenna(s) and circular polarization. Support for LTE-based narrow-band IoT (NB-IoT) and eMTC type devices are also standardized in Rel-17. Regardless of device type, it is assumed all Rel-17 NTN WTRUs are global navigation satellite system (GNSS) capable.

### SUMMARY

A basic non-terrestrial network (NTN) may comprise an aerial or space-borne platform which, via a gateway (GW), may transport signals from a land-based base station (e.g., a gNB) to a WTRU, and vice-versa. NTN may support LTE-based narrow-band IoT (NB-IoT) and eMTC-type devices.

In a NTN network, a feeder link is a wireless link between a gateway (GW) and the satellite. A service link is a link between the satellite and a WTRU. An inter-satellite link (ISL) is a transport link between satellites. An ISL is supported only by regenerative payloads and may be a 3GPP radio or a proprietary optical interface.

A store and forward (S&F) satellite operation is a mode where some level of service, based on storing and forwarding the data, when satellite connectivity is intermittently/temporarily unavailable, e.g. to provide communication service for UEs under satellite coverage via the service link without a simultaneous active feeder link, i.e., while the feeder link is unavailable. In a store and forwards (S&F) mode, the equipment on board the satellite either has connectivity over the service link (i.e., with the WTRUs) or with the terrestrial network equipment via the feeder link. If the feeder link is not available, all requests (e.g., for authentication or data transmission), including the associated upstream data, have to be cached on board the satellite. Such caching presents a vulnerability that can be exploited by an adversary in mounting a (D)DOS attack on the availability of the RAN and CN equipment on board the satellite. It is desired to support means to mitigate the potential denial of service attack in the S&F satellite operation.

Usually, remediation and throttling of DOS/DDOS attacks require the attacking entities to be authenticated and throttled based on their authorization status. However, considering that the unauthenticated entities may engage in attacks on the network entities and links engaged in Authentication and Authorization, requiring authentication may not always be possible. But since authentication processes may be used to mount DOS/DDOS attacks, expecting to throttle only authenticated entities may not be a useful remediation for such DOS/DDOS attacks. A new approach to DOS/DDOS remediation may be beneficial.

The remediation of such attacks on availability may be achieved by selecting a system architecture where the Edge Network Node (ENN) is fully responsible for the Authentication and Authorization of entities, or by implementing a throttling mechanism that would allow mitigation of availability attacks (i.e., DOS), while affecting the malicious/attacking entities in disproportional ways as compared to legitimate entities.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates the interfaces defined for non-terrestrial networks (NTN);

FIG. 3 illustrates the main aspects of the existing approaches;

FIG. 4 illustrates the main aspects of the invention;

FIG. 5 illustrates an example of registration with puzzle, according to an embodiment;

FIG. 6 illustrates another example of registration with puzzle, according to an embodiment;

FIG. 7 illustrates an example of configuration and assembly of a cryptographic puzzle based on reversing encryption;

FIG. 8 illustrates an example of a configuration and assembly a puzzle;

FIG. 9 illustrates an example of solving an encryption reversal puzzle;

FIG. 10 illustrates an example of solving a one-way cryptographic hash function;

FIG. 11 illustrates an example of ENN processing the Evidence parameter received from the UnEn;

FIG. 12 illustrates an example call flow of the initiation of a (D)DOS remediation procedure in the context of satellite in S&F mode;

FIG. 13 shows an example of a (D)DOS remediation procedure in the context of satellite in S&F mode according to one embodiment;

FIG. 14 shows an example of a (D)DOS remediation procedure in the context of satellite in S&F mode according to another embodiment; and

FIG. 15 illustrates an example call flow of the completion of a (D)DOS remediation procedure in the context of satellite in S&F mode.

### DETAILED DESCRIPTION

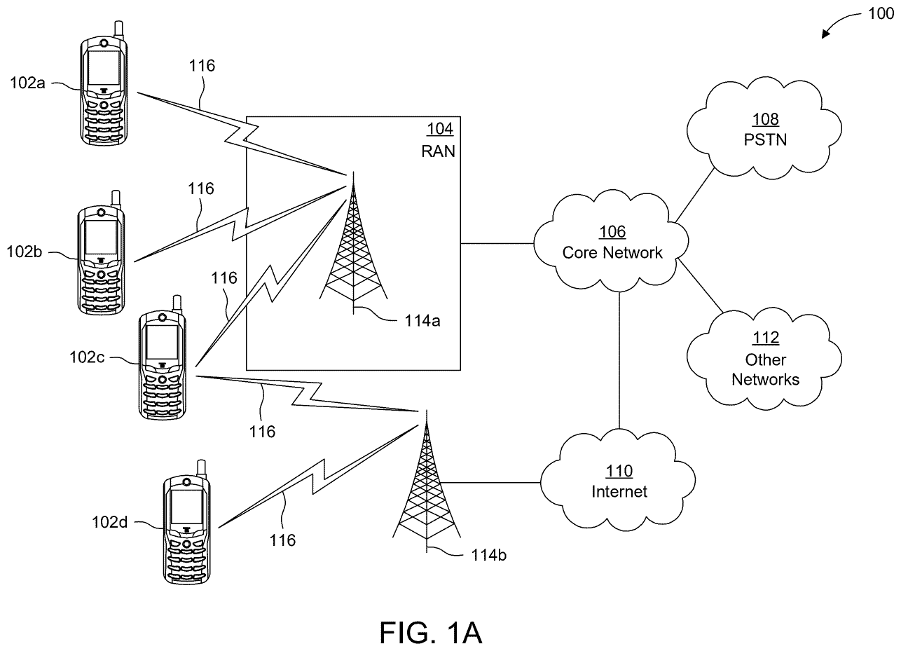

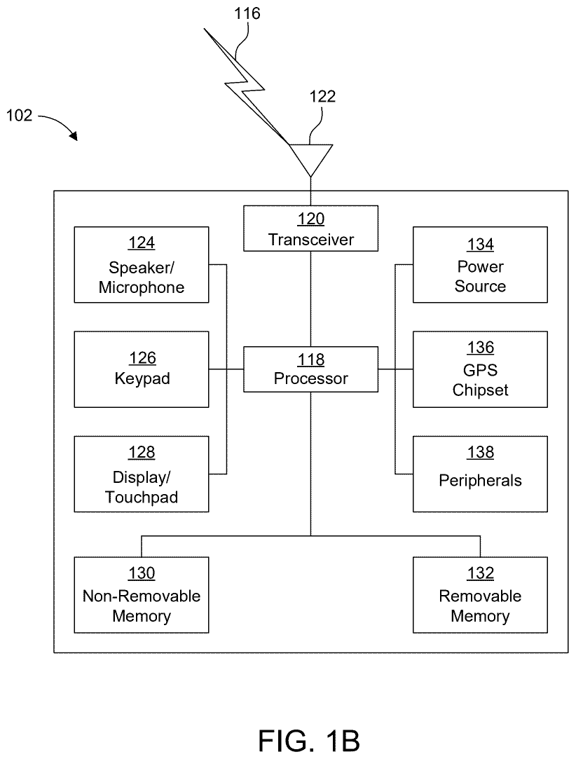

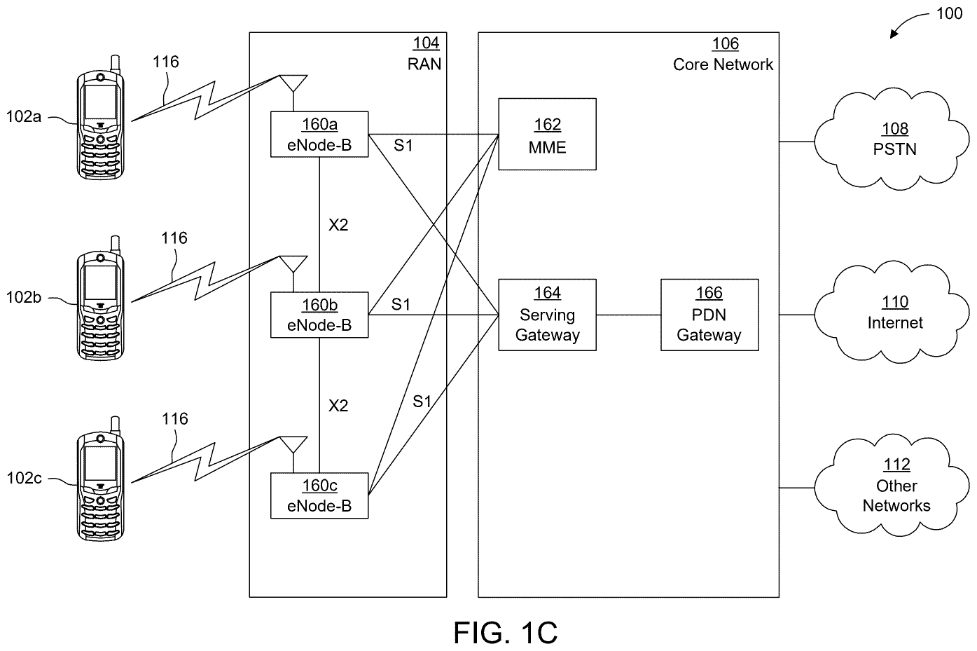

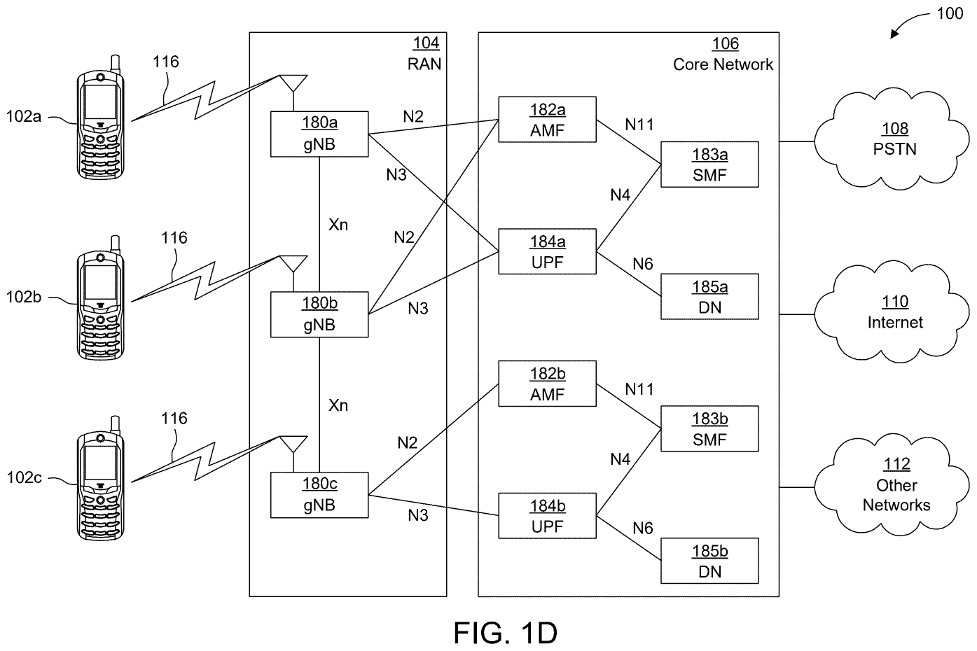

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUS 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11 af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QOS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A basic non-terrestrial network (NTN) may comprise an aerial or space-borne platform which, via a gateway (GW), may transport signals from a land-based base station (e.g., a gNB) to a WTRU, and vice-versa. NTN may support LTE-based narrow-band IoT (NB-IoT) and eMTC-type devices. It is generally assumed that NTN WTRUs are GNSS capable.

Aerial or space-borne platforms are classified in terms of orbit, such as low-earth orbit (LEO) satellites, with an altitude range of 300-1500 km, geostationary earth orbit (GEO) satellites, with an altitude of 35786 km, medium-earth orbit (MEO) satellites, with an altitude range of 7000-25000 km, and high-altitude platform stations (HAPS), with an altitude of 8-50 km are assumed to be implicitly supported. Satellite platforms are further classified as having a “transparent” or “regenerative” payload. Transparent satellite payloads implement frequency conversion and RF amplification in both uplink and downlink, with multiple transparent satellites possibly connected to one land-based gNB. Regenerative satellite payloads can implement either a full gNB or gNB DU onboard the satellite. Regenerative payloads may perform digital processing on the signal including demodulation, decoding, re-encoding, re-modulation, and/or filtering.

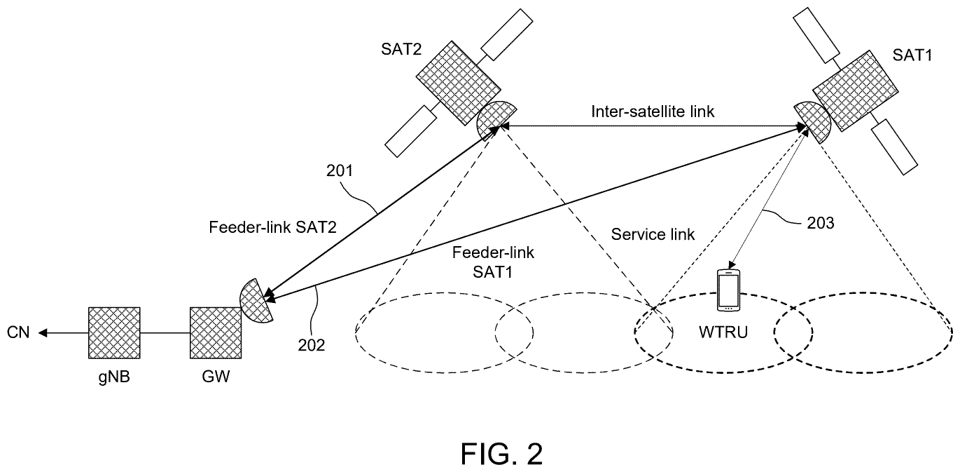

FIG. 2 illustrates the interfaces defined for non-terrestrial networks (NTN). A feeder-link 201, 202 is a wireless link between a GW and the satellite. A service link 203 is a link between the satellite and a WTRU. Inter-satellite link (ISL) is a transport link between satellites. An ISL is supported only by regenerative payloads and may be a 3GPP radio or a proprietary optical interface.

An NTN satellite may be able to support multiple cells, where each cell comprises one or more satellite beams. Satellite beams cover a footprint on earth (similar to a terrestrial cell) and may range in diameter from 100-1000 km in LEO deployments, and 200-3500 km diameter in GEO deployments. Beam footprints in GEO deployments remain fixed relative to the Earth, and in LEO deployments the area covered by a beam/cell may change over time due to satellite movement. This beam movement can be classified as “earth moving” where the LEO beam moves continuously across the earth, or “earth fixed” where the beam is steered to remain covering a fixed location until a new cell overtakes the coverage area in a discrete and coordinated change.

Due to the altitude of NTN platforms and beam diameter, the round-trip time (RTT) and maximum differential delay may be significantly larger than that of terrestrial systems. In a typical transparent NTN deployment, RTT may range from 25.77 ms (LEO @ 600 km altitude) to 541.46 ms (GEO), and maximum differential delay may range from 3.12 ms to 10.3 ms. The RTT of a regenerative payload may be approximately half that of a transparent payload, as a transparent configuration comprises both the service and feeder links, whereas the RTT of a regenerative payload comprises the service link only. To minimize the impact on existing NR systems (e.g. to avoid preamble ambiguity or properly time reception windows), before initial access, a WTRU may perform timing pre-compensation.

The pre-compensation procedure may require the WTRU to obtain its position via GNSS, and the feeder-link (or common) delay and satellite position via satellite ephemeris data. The satellite ephemeris data may be periodically broadcast in system information and may include the satellite speed, direction, and velocity. The WTRU may then estimate the distance (and thus delay) from the satellite, and add the feeder-link delay component to obtain the full WTRU-eNB RTT, which may be used to offset timers, reception windows, or timing relations. It is assumed that frequency compensation is performed by the network.

Other key enhancements in NTN relate to WTRU mobility and measurement reporting. The difference in RSRP between cell center and cell edge may not be as pronounced as in terrestrial systems. This, coupled with the much larger region of cell overlap, results in traditional measurement-based mobility being less reliable in an NTN environment. Conditional handover and measurement reporting triggers relying on location and time may be used in both NR and IoT-NTN. Enhanced mobility may be of special interest in LEO deployments where, due to satellite movement, even a stationary WTRU is expected to perform mobility approximately every 7 seconds (depending on deployment characteristics).

In store and forward (S&F) mode, the equipment on board the satellite either has connectivity over the service link (i.e., with the WTRUs) or with the terrestrial network equipment via the feeder link. If the feeder link is not available, all requests (e.g., for authentication or data transmission), including the associated upstream data, have to be cached on board the satellite. Such caching presents a vulnerability that can be exploited by an adversary in mounting a (D)DOS attack on the availability of the RAN and CN equipment on board the satellite. It is desired to support means to mitigate the potential denial of service attack in the S&F satellite operation.

Terminology used herein: A Unauthenticated Entity (UnEn) may be a WTRU. An Edge Network Node (ENN) may be a base station (e.g., either terrestrial or satellite-based) or an access point.

The term Shared Secret as used herein may be, in some embodiments, a shared secret key.

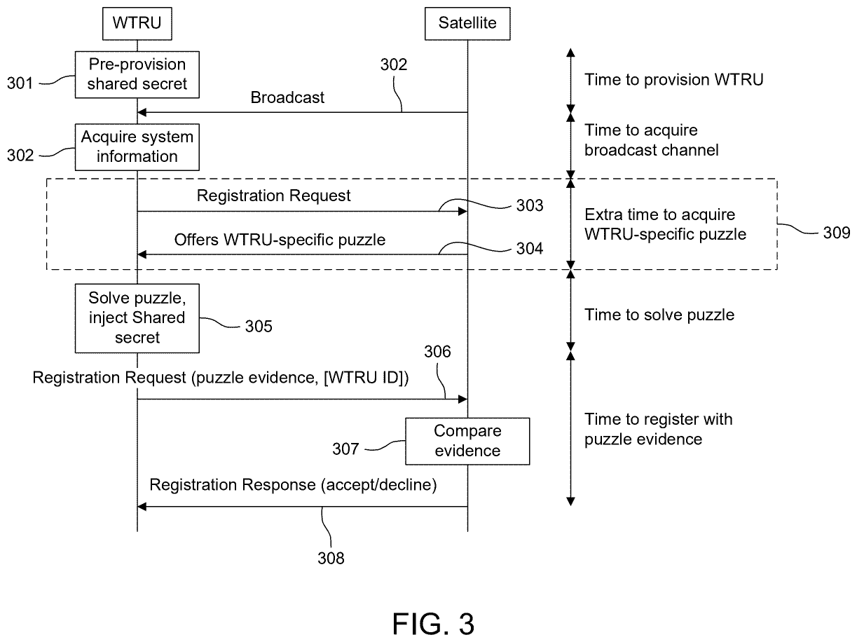

FIG. 3 illustrates the main aspects of the existing approaches.

In general, the Authentication Function, Edge Network Node, and Unauthenticated Entity distribute between them Shared Secret and other parameters such as Unauthenticated Entity (UnEn) identity 301.

The first step for the Unauthenticated Entity (e.g., WTRU) may be to acquire the cell's system information, which is sent in the broadcast channel 302.

The Unauthenticated Entity (e.g., WTRU) may send a registration request 303. Before continuing with the registration procedure, the Edge Network Node may determine an appropriate task, such as a, puzzle and send it to the Unauthenticated Entity 304.

The Unauthenticated Entity may complete the assigned task (e.g., solving the puzzle), inject or cryptographically bind it with the Shared Secret, and optionally, also with its identity and other pre-provisioned parameters 305.

The Unauthenticated Entity may send an Authentication Request including the obtained evidence from solving the puzzle and the optional parameters, such as its identity, to the Edge Network Node 306.

The Edge Node may compare the received result with the expected result 307. If the comparison is successful, the Edge Node may forward the Authentication Request from the Unauthenticated Entity to the Authentication Function, to complete the process 308.

As shown in the example in FIG. 3, there is an extra time 309 added to the procedure which is required for the WTRU to acquire the WTRU-specific puzzle. This time is extra when compared with a regular registration procedure without a puzzle challenge. This time is dependent on the round trip time (RTT) between the Unauthenticated Entity and the satellite. Accordingly, this may be a long time, and it is therefore beneficial to find ways to reduce or eliminate this extra time 309.In other words, the current (D)DOS remediation procedure has an additional delay 309 caused by the added round-trip and there is a desire to optimize the procedure to avoid the unnecessary round-trip delay. Also, the same procedure does not check for the availability of the feeder link (FL) before commencing, causing additional processing and signaling load on involved entities.

Usually, remediation and throttling of DOS/DDOS attacks require the attacking entities to be authenticated and throttled based on their authorization status. However, considering that the unauthenticated entities may engage in attacks on the network entities and links engaged in Authentication and Authorization, requiring authentication may not always be possible.

Since authentication processes may be used to mount DOS/DDOS attacks, expecting to throttle only authenticated entities may not be a useful remediation for such DOS/DDOS attacks. A new approach to DOS/DDOS remediation may be beneficial.

For example, if only edge network nodes are engaged in Authentication and Authorization, only those nodes may be a potential DOS/DDOS victim. However, if core network nodes are engaged in Authentication and Authorization, the attack may not be limited to the edge node(s), but rather it may affect core network functionality and interfaces (e.g., UDM/UDR in 5GS).

The remediation of such attacks on availability may be achieved by selecting a system architecture where the Edge Network Node (ENN) is fully responsible for the Authentication and Authorization of entities, or by implementing a throttling mechanism that would allow mitigation of availability attacks (i.e., DOS), while affecting the malicious/attacking entities in disproportional ways as compared to legitimate entities.

In one example, a Shared Secret and other parameters may be pre-provisioned in the WTRU (e.g., out of band). The eNB (MME) or gNB (AMF) on board of the satellite may check if the feeder link is available. If it is, the (D)DOS attack on availability is comparable to similar (D)DOS attacks in terrestrial networks, and the network equipment on board the satellite may follow similar terrestrial procedures.

A puzzle, common to a group of WTRUs in the cell, or all WTRUs in the cell, may be selected/determined by the gNB. The puzzle may be sent by the gNB in a broadcast message.

A WTRU may receive the broadcast message including the puzzle. The WTRU may solve it, and while solving the puzzle, the WTRU may inject into the solution process the Shared Secret, and optionally other parameters that were pre-provisioned. The result of solving the puzzle is referred to as evidence. The intent of the injection is to make the evidence obtained from the common puzzle to be distinguishable per WTRU (i.e., WTRU-specific evidence).

In another example, a Shared Secret and other parameters may be pre-provisioned in the WTRU (e.g., out of band). The eNB (MME) or gNB(AMF) on board of the satellite checks if the feeder link is available. If yes, the (D)DOS attack on availability is comparable to similar (D)DOS attacks in terrestrial networks, and the network equipment on board the satellite may follow similar terrestrial procedures.

When a WTRU is provisioned, the identity of the WTRU may be traversing the eNB/gNB. At that time, the eNB/gNB learns of the presence of the WTRU, and saves the identity of the WTRU, and uses a pre-provisioned mapping table to map the WTRU identity to a shared key. The WTRU identity may be an IMSI, a SUPI or a SUCI.

The eNB/gNB selects/determines a puzzle, common to a group of WTRUs in the cell, or to all WTRUs in the cell. Based on the WTRU identities, the eNB (MME) or gNB(AMF) on board of the satellite may determine the share key and solve the puzzle. While solving the puzzle, it may inject the Shared Secret associated with a WTRU. The intent of the injection is to make the evidence obtained from the common puzzle to be distinguishable per WTRU. The eNB/gNB saves the result/evidence of the puzzle solving for every WTRU in the group/cell.

The selected puzzle may be common for more than one WTRU and is offered via e.g., broadcast or SIB. The WTRU may receive the broadcast, solve and inject into the solution process the Shared Secret (and optionally other parameters received during pre-provisioning). The intent of the injection is to make the evidence obtained from the common puzzle to be distinguishable per WTRU.

Note that in the first example, the eNB (MME) or gNB(AMF) on board of the satellite produces the expected evidence upon the receipt of the evidence from the WTRU. In the second example, the expected evidence is pre-computed and stored to be retrieved and compared with the evidence received from the WTRU later.

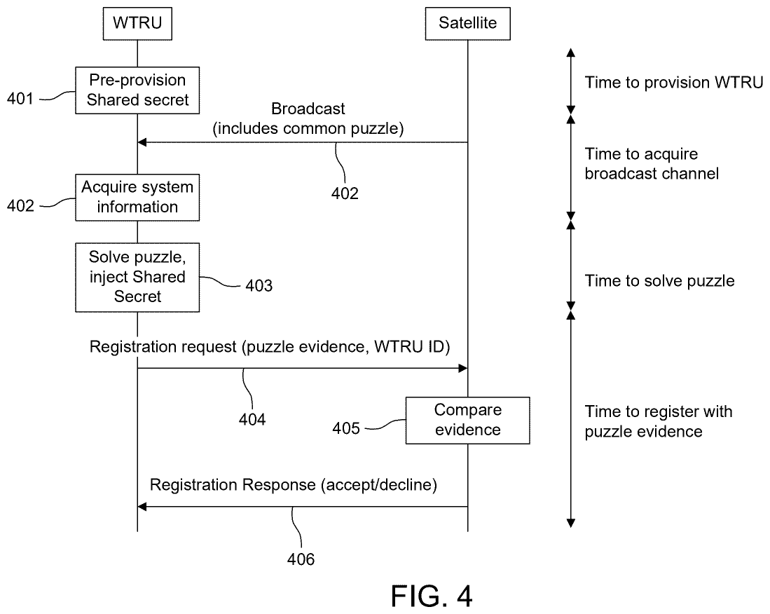

FIG. 4 illustrates the main aspects of the invention.

Initially, the Authentication Function, Edge Network Node, and Unauthenticated Entity may distribute Shared Secret and other parameters, such as Unauthenticated Entity (e.g., UE, WTRU) identity 401.

The Edge Network Node may determine an appropriate task, e.g., a puzzle, and may broadcast it to the Unauthenticated Entity 402.

An Unauthenticated Entity may complete the assigned task (e.g., solve the puzzle), inject or cryptographically bind the evidence with the Shared Secret, and optionally, with its identity and other pre-provisioned parameters 403.

The Unauthenticated Entity may send an Authentication Request, including the obtained evidence and the WTRU identity to the Edge Network Node 404. Depending on the embodiment, the transmission of the Unauthenticated Entity identity in this message may be optional.

The Edge Network Node may compute the expected evidence by solving the puzzle the same way the Unauthenticated Entity solved and inject or cryptographically bind the result with the Shared Secret and,. optionally, other pre-provisioned parameters such as WTRU identity. After that, the Edge Node may compare the received result with the expected result 405. If the comparison is successful, the Edge Node may forward the Authentication Request from the Unauthenticated Entity to the Authentication Function, to complete the process 406. As it is shown, the extra time 309 that was present in the example in FIG. 3 has been eliminated, yielding in a fast and more efficient procedure for the registration with puzzle.

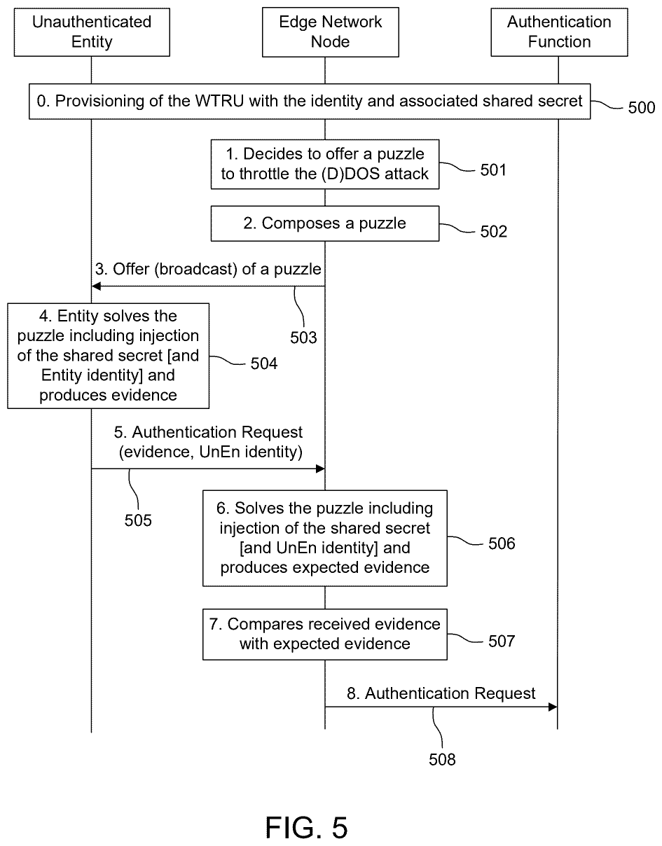

FIG. 5 illustrates an example of registration with puzzle, according to an embodiment.
0. The Unauthenticated Entity (UnEn) may be provisioned with the Shared Secret and, optionally, with its identity and other parameters 500. The Edge Network Node (ENN) may create the required relationships for the UnEn and its identity, Shared Secret, and other pre-provisioned parameters. The ENN may maintain a mapping between provisioned Shared Secret values, Identities, and other parameters.
1. ENN may decide to use a puzzle to remedy a potential DDOS attack 501. Deciding to remedy a potential DDOS attack may be based on a request from a core network node. For example, a core network node may indicate to the ENN that a potential DDOS attack may be underway. The core network node may make this determination after observing a relatively high number of failed authentication attempts.
2. ENN may compose a puzzle 502. Refer to later paragraphs for more details on this step.
3. ENN may offer (e.g., broadcast) a puzzle composed in step 2 to UnEn(s) 503. The ENN may include the puzzle parameters in the broadcast. A puzzle index may also be included to identify one puzzle out of a set of pre-defined or pre-configured puzzles. The puzzle information and parameters may be sent in an existing system information block. Optionally, a new system information block may be specified to carry the puzzle parameters.
4. UnEn may solve the puzzle received in step 3, obtain the evidence bound to the Shared Secret and, optionally to e.g., UnEn identity and other pre-provisioned (in step 0) parameters 504. Refer to later paragraphs for more details on this step.
5. The UnEn may send an Authentication Request message to the ENN containing the evidence of the solved puzzle and, optionally, UnEn identity and other pre-provisioned parameters 505.

In some embodiments, the UnEn identity may not be used in the puzzle injection, but may still be transmitted from the WTRU to the satellite. This may be required for the network equipment on board of the satellite to find the Shared Secret associated with the WTRU, as the relationship was created during pre-provisioning. may be done by maintaining a relationship between WTRU identity and Shared Secret.
6. The ENN may obtain the Shared Secret for the UnEn and solve the puzzle and cryptographically binds the result to the Shared Secret and, optionally, to the UnEn identity and other pre-provisioned parameters 506.
7. ENN may verify that the received evidence corresponds to the puzzle from step 3 and that it is uniquely bound to the Shared Secret and, optionally, UnEn identity and other pre-provisioned parameters 507.
8. Upon the successful verification in step 6, ENN may forward the Authentication Request to the Authentication Function 508.

In another example, solving the puzzle together with the injection of the Shared Secret (and optionally other pre-provisioned parameters) may be performed after step 2. This verification may be achieved either for individual UnEns or for a group of UnEns.

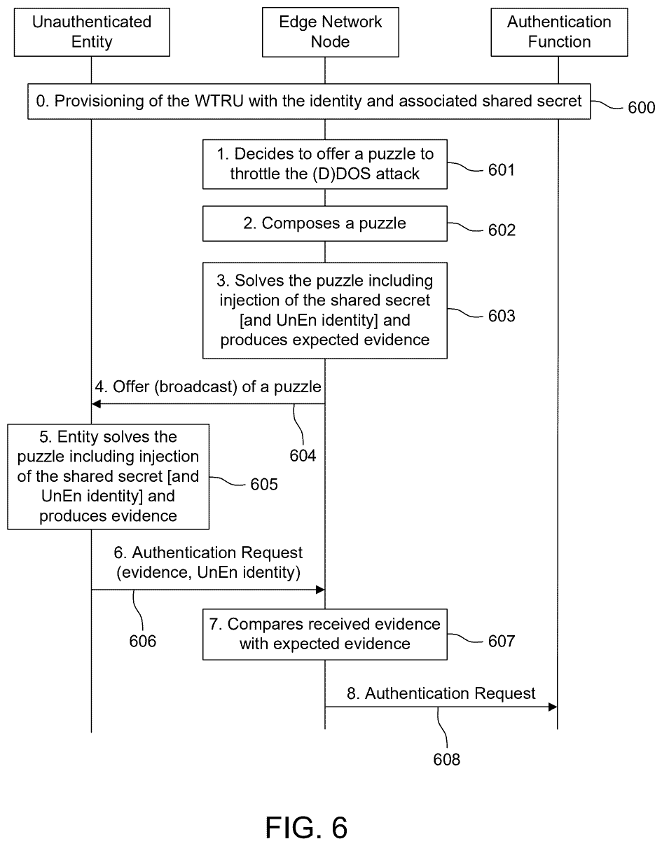

FIG. 6 illustrates another example of registration with puzzle, according to an embodiment.
0. The Unauthenticated Entity may be provisioned with the Shared Secret and, optionally, with its identity and other parameters 600. The Edge Network Node keeps a mapping between provisioned Shared Secret values, optional identities, and other parameters.
1. ENN may decidesto use a puzzle to remedy a potential DDOS attack 601. Deciding to remedy a potential DDOS attack may be based on a request from a core network node. For example, a core network node may indicate to the ENN that a potential DDOS attack may be underway. The core network node may make this determination after observing a relatively high number of failed authentication attempts. The core network may make this determination based on a recorded DDOS attack at the same or nearby locations. The core network may make this determination based on the received request types, patterns, and rate.
2. ENN may compose a puzzle 602. Refer to later paragraphs for more details on this step.
3. ENN may solve the puzzle for an UnEn and cryptographically bind the result to the Shared Secret of that UnEn and, optionally, to the UnEn identity and other pre-provisioned parameters of the UnEn 603. The ENN may maintain a mapping between the UnEn identity and the Shared Secret of the UnEn identity based on the information that was provided during the pre-provisioning and use that information to solve the puzzle. The ENN may perform this pre-solving process for a set of UnEn that are provisioned, or all UnEn that are provisioned via that ENN. The evidence may then be saved by the ENN for future use,
4. ENN may offer (e.g., broadcasts) a puzzle composed in step 2 to UnEn(s) 604.
5. UnEn may solve the puzzle received in step 3, obtain the evidence bound to the Shared Secret and, optionally, to e.g., UnEn identity and other pre-provisioned (in step 0) parameters 605. Refer to later paragraphs for more details on this step.
6. The UnEn may send an Authentication Request to the ENN containing the evidence of the solved puzzle, the UnEn identity and, optionally, other pre-provisioned parameters 606.
7. ENN may verify that the received evidence corresponds to the puzzle from step 3 and that it is uniquely bound to the Shared Secret and, optionally, to the UnEn identity and, optionally, other pre-provisioned parameters 607.
8. Upon the successful verification in step 6, ENN may forward the Authentication Request to the Authentication Function 608.

A puzzle may comprise any cryptographic primitive (e.g., encryption, hash function, etc.) that may require brute-force attack to reverse the encryption. Because of that, a few aspects need to be taken into consideration when selecting a puzzle. Firstly, it may be necessary to find plaintext or partial plaintext with either no encryption key knowledge, partial key knowledge, or reduced key size. By increasing/decreasing the key size or other parameters it is possible to modulate the strength of the puzzle and the amount of work/effort that an entity (e.g., a WTRU) has to spend to solve it. The processor productivity may have an outsized effect on the time needed to reverse encryption. As an example, key length (e.g., 128 for AES-128), known key length (e.g., 120, leaving 8 bits for brute-force attack), and cyphertext could be puzzle parameters. Cleartext corresponding to the cyphertext will be the puzzle evidence obtained as a result of a brute-force attack.

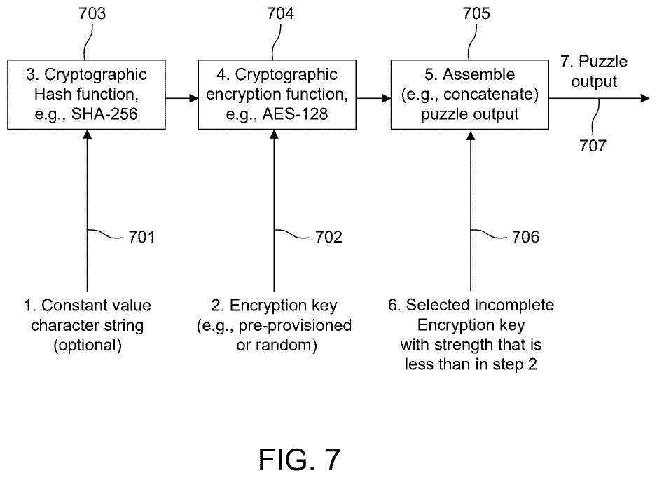

FIG. 7 illustrates an example of configuration and assembly of a cryptographic puzzle based on reversing encryption.

The example procedure of FIG. 7 may be triggered by the ENN. The procedure may be triggered when the ENN receives an Authentication Request, and the ENN may decide that it will use a puzzle to remedy a potential DDOS attack. The ENN may trigger this procedure so that it can obtain a puzzle to send to the UnEn.

In this example, a constant value character string is selected to aid in the selection of the correct key during the brute-force reversing of encryption 701. An encryption key of the strength (i.e., full strength) corresponding to the encryption function is selected (e.g., random, or pre-provisioned) 702. Then a hash function produces a normalized length hashed output 703. A cryptographic encryption function produces the puzzle 704 for the next step 705. The puzzle is assembled e.g., by concatenating the encrypted text, the incomplete encryption key (from step 2) and the optional constant from step 3.

An incomplete encryption key based on the value obtained from step 4 is selected 706. For example, if the full-strength key from step 4 is 128 bits long, the key selected in step 6 will be of length/strength that is less than 128 bits long. The resulting length of e.g., 1-127 bits will allow to modulate the puzzle strength and efforts needed to reverse the encryption. The assembled puzzle is ready for solving by UnEn 707. The resulting puzzle comprises the encrypted text and the incomplete encryption key from step 6.

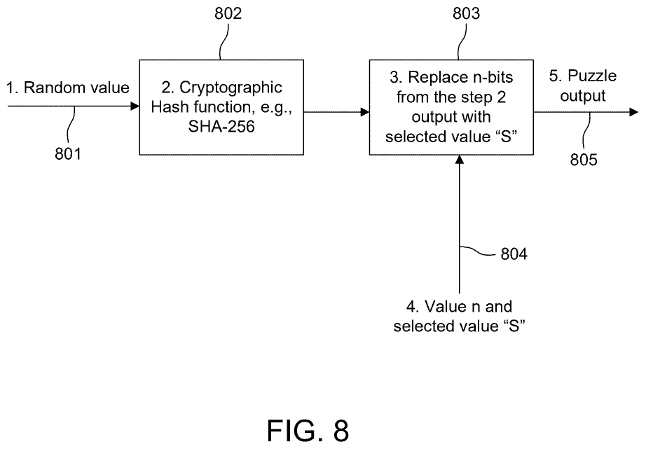

In an example of reversing of one-way cryptographic hash function (e.g., SHA-256), involves finding the input argument with a partial input hash function argument knowledge. By increasing/decreasing the proportion between known and unknown portions of the hash function input it may be possible to modulate the strength of the puzzle and the amount of work/effort that an entity (e.g., a WTRU) has to spend to solve it. RAM productivity has an outsized effect on the time needed to reverse the hash function. The partially known argument to the cryptographic hash function will be the input parameter. For example, when using SHA-256 cryptographic hash, the input string to the hash has a total length of N and a known input length of N-m. The hash output is provided as one of the input parameters (stated length of 256 for SHA-256). It is the m-bits of the input to the hash function that are not known and comprise the puzzle. The effort will be needed to use a brute-force attack and discover the unknown m-bits of input, so that output=HASH-256 (known input∥unknown input). The unknown input of the full length of the input is the evidence FIG. 8 illustrates an example of a configuration and assembly a puzzle.

In the example in FIG. 8, a random value is either selected or pre-provisioned 801. A hash function may be used to normalize the length of the input 802. A certain number of bits, e.g., ‘n’ bits, may be replaced (either leading, trailing, or random) with a selected character ‘S’ 803. Step 4 provides means for the selection of n-bit value and replacement character ‘S’ 804. The puzzle is assembled and ready to be solved by UnEn 805. It comprises the output of step 2 and the selected ‘S’character (optional).

Solving an encryption reversal puzzle is based on the “brute-force” method and it comprises finding plaintext or partial plaintext with either no encryption key knowledge, partial key knowledge, or reduced key size. As previously mentioned, the processor productivity has an outsized effect on the time/effort needed to reverse encryption. The procedure of solving this puzzle type is built around going through all existing permutations of the whole encryption key while knowing the partial encryption key.

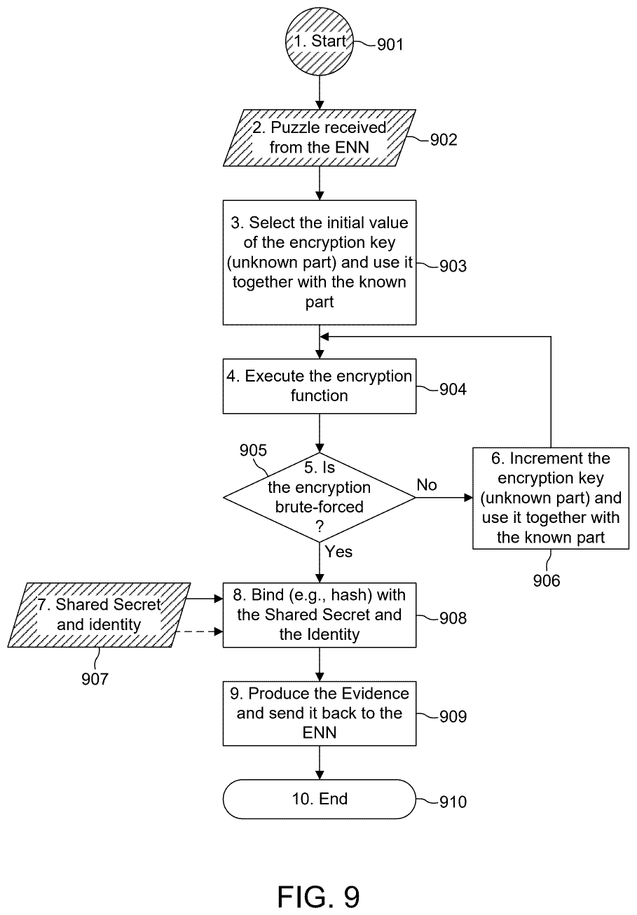

FIG. 9 illustrates an example of solving an encryption reversal puzzle.

The procedure starts at step 1, 901. The UnEn receives the puzzle and corresponding parameters from the ENN 902. The puzzle and the parameters correspond to what was generated as the puzzle output in step 7 FIG. 7 707. This corresponds to step 4 in FIGS. 3, 304.

The UnEn selects the initial (e.g., the starting value of the unknown part of the encryption key and uses it together with the known part of the key 903. The UnEn executes the encryption function 904. The UnEn checks if the encryption is brute-forced 905. For example, it checks if the brute-forced cleartext contains the optional known clear text corresponding to a puzzle parameters provided, e.g., FIG. 5, step 3, 503.

If No 906, the UnEn increments the unknown part of the key, uses that part together with the known part, and tries to brute-force the encryption again in step 4. If Yes, the process proceeds to step 7 907. Step 7 907 contains pre-provisioned to the UnEn Shared Secret, optional identity, and/or other pre-provisioned parameters.

The UnEn binds the output of step 6 with the UnEn Shared Secret 908, optional identity, and/or other pre-provisioned parameters. The evidence is comprised of the solved (i.e., brute-forced) encrypted text that is bound to the Shared Secret and, optionally, the identity, and/or other pre-provisioned parameters 909. The UnEn sends the evidence to the ENN. Sending the evidence corresponds to step 4 of FIGS. 4, 404. The procedure ends 910.

Solving a one-way cryptographic hash function (e.g., SHA-256) reversing puzzle is based on the “brute-force” method and it comprises finding the complete hash function input text with only partial input hash function argument knowledge. Increasing/decreasing the proportion between known and unknown portions of the hash function input may modulate the strength of the puzzle and the amount of work/effort that an entity (e.g., a WTRU) has to spend to solve it. RAM productivity has an outsized effect on the time needed to reverse the hash function The partially known argument to the cryptographic hash function may be the input parameter. For example, when using SHA-256 cryptographic hash, the input string to the hash has a total length of N and a known input length of N-m. The hash output may be provided as one of the input parameters (stated length of 256 for SHA-256). It is the m-bits of the input to the hash function that are not known, and those comprise the puzzle. The effort may be the use of brute-force attack and discover the unknown m-bits of input, so that output=HASH-256 is the concatenated of known and previously unknown bits (known input∥unknown input). Evidence produced in the process of solving the puzzle comprises the full length of hash input.

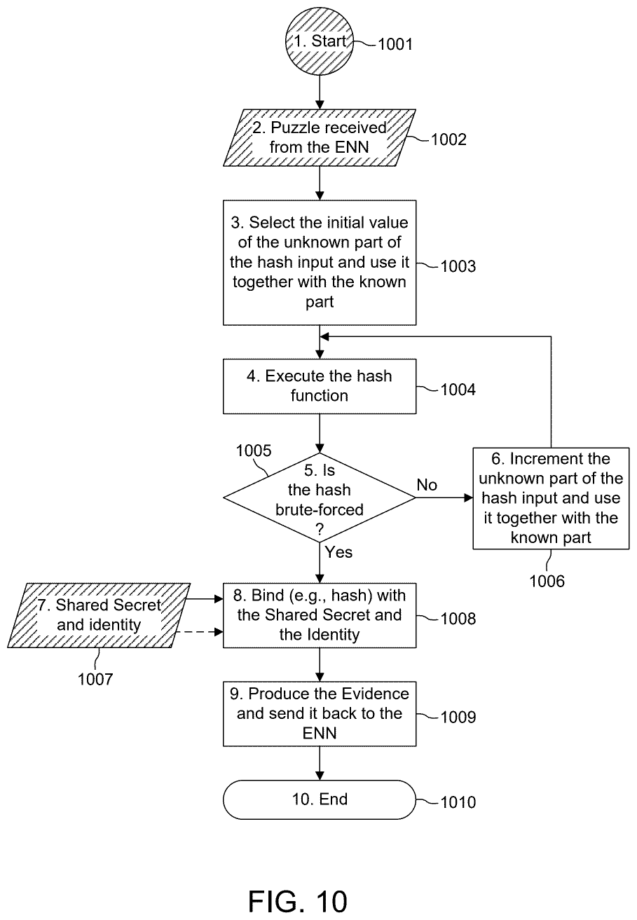

FIG. 10 illustrates an example of solving a one-way cryptographic hash function The procedure starts in step 1, 1001. The UnEn receives the puzzle and corresponding parameters from the ENN 1002. The puzzle and the parameters correspond to what was generated as a puzzle output in FIGS. 7, 707. This corresponds to step 4 in FIGS. 3, 304.

The UnEn selects the initial (e.g., the starting value of the unknown part of the hash input and uses it together with the known part of the hash input 1003. The UnEn executes the hash function 1004. The UnEn checks if the hash is brute-forced (e.g. if the hash output corresponds to the whole hash input) 1005.

If No 1006, the UnEn increments the unknown part of the hash input, uses that part together with the known part, and tries to brute-force the hash again in step 4. If Yes, the process proceeds to step 7 1007.

Step 7 1007 contains pre-provisioned to the UnEn Shared Secret, optional identity, and/or other pre-provisioned parameters. The UnEn binds the output of step 6 with the UnEn Shared Secret, optional identity, and/or other pre-provisioned parameters 1008. The evidence is comprised of the solved (i.e., brute-forced) complete hash input text bound with the UnEn Shared Secret, optional identity, and/or other pre-provisioned parameters 1009. The UnEn sends the evidence to the ENN. S ending the evidence corresponds to step 4 of FIGS. 4, 404. The procedure ends 1010.

The UnEn may solve the puzzle and recover he evidence. If the Evidence (e.g., recovered cleartext) was bound with the UnEn identity and/or the replay prevention parameter, it is still bound to the UnEn identity and is replay-resistant (i.e., another entity cannot present the Evidence and/or the Evidence cannot be replayed by the same or different UnEn).

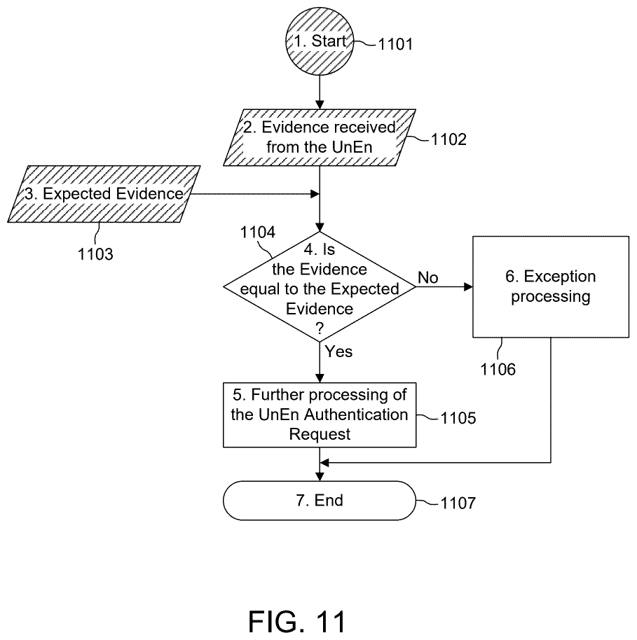

FIG. 11 illustrates an example of ENN processing the Evidence parameter received from the UnEn.

The procedure starts in step 1 1101. The ENN receives Evidence from UnEn 1102. This corresponds to step 6 in FIGS. 5, 506. The ENN recalls saved Expected Evidence 1103. The ENN compares the received Evidence with the Expected Evidence 1104.

If the comparison is successful, it proceeds to step 5 1105. The violation of the UnEn binding and/or replay protection would lead to the Evidence submitted by the UnEn being not equal to the Expected Evidence. The ENN may allow further processing of the UnEn Authentication Request 1105. Exception processing 1106 may include sending an additional message to UnEn or just a “silent drop” of the Authentication Request (see FIG. 5 step 7, 507). The procedure ends 1107.

In one example, an ENN may perform the following actions. An ENN may determine to execute a procedure to throttle, or mitigate, a (D)DOS attack. The determination may be based on a request from a core network node. An ENN may determine a puzzle. The puzzle may include encrypted text, an incomplete encryption key, and a character string. An ENN may send a puzzle to a UnEn (e.g., WTRU). An ENN may receive a second authentication request from a UnEn. The second authentication request may include the Evidence. The ENN, based on the evidence of solving the puzzle correctly, may determine to send the second authentication request to an Authentication Function.

In one example, a UnEn may perform the following actions. A UnEn may receive a puzzle from the network. The puzzle may include encrypted text, an incomplete encryption key, and a character string. A UnEn may obtain evidence of solving the puzzle. A UnEn may send a second authentication request to a network. The second authentication request may include the evidence.

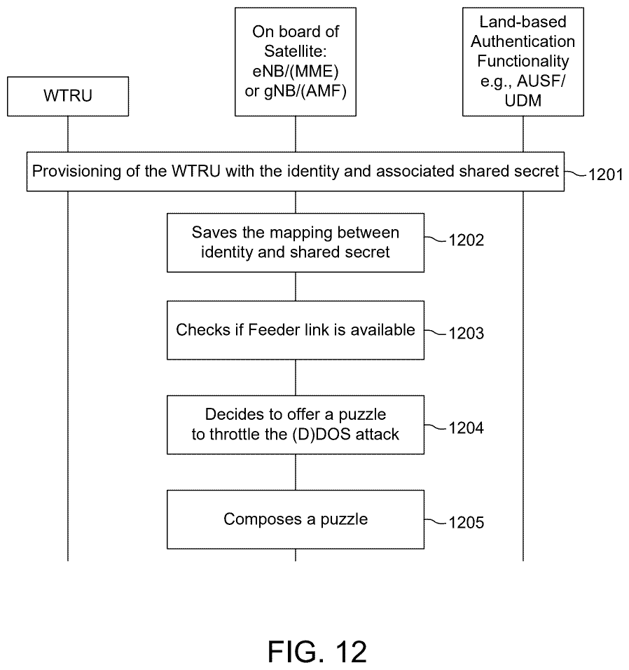

FIG. 12 illustrates an example call flow of the initiation of a (D)DOS remediation procedure in the context of satellite in S&F mode.

Initially, the WTRU may be provisioned with a Shared Secret, WTRU identity and other parameters 1201. When the WTRU is being provisioned, the network equipment on board the satellite (e.g., eNB, gNB) may store the WTRU identity and the associated Share Secret, e.g., in a mapping table 1202. The provisioning may be achieved out-of-band. The Shared Secret may be a separate from the existing Shared Secret used for primary authentication. The relationship between WTRU identity and its Shared Secret may be used in a future step by the network equipment on board the satellite to verify the evidence provided by the WTRU.

The network equipment on board the satellite may check if the feeder link is available 1203. If yes, the (D)DOS attack on availability is comparable to similar (D)DOS attacks in terrestrial networks, and the network equipment on board the satellite proceeds with the registration procedure.

The network equipment on board the satellite may decide to use puzzles to throttle/remediate a (D)DOS attack 1204. The decision by the network equipment on board the satellite to use puzzles to throttle/remediate a (D)DOS attack may be based on the unavailability of the feeder link, possibly combined with other factors.

The network equipment on board the satellite may compose a puzzle 1205. The puzzle may be a common puzzle, rather than a WTRU-specific puzzle. Composing puzzles may be delegated to other network entities and/or functions that may preconfigure the puzzle and determine the puzzle evidence.

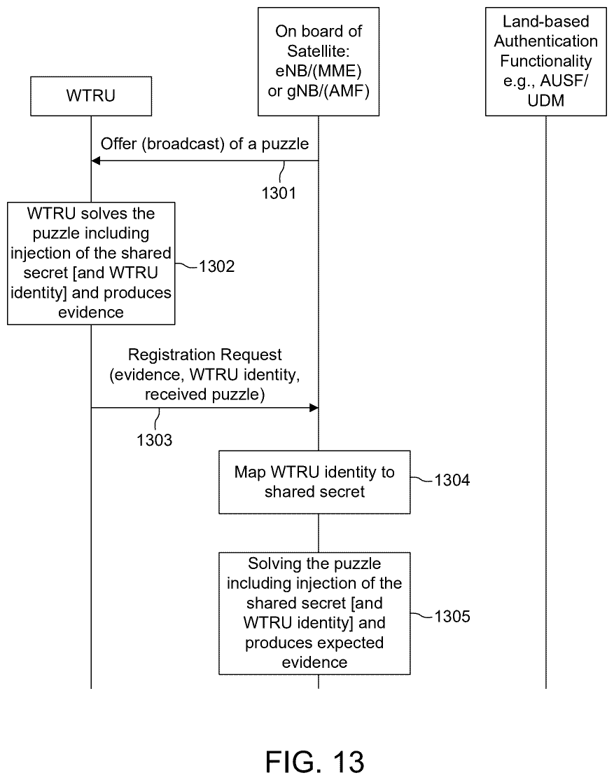

FIG. 13 shows an example of a (D)DOS remediation procedure in the context of satellite in S&F mode according to one embodiment.

The procedure in FIG. 13 may start after the network equipment on board the satellite completed the puzzle preparation/composition. The network equipment on board the satellite may offer (e.g., broadcasts) the puzzle previously composed 1301. Optionally, a puzzle index may be transmitted indicating which puzzle to use out of a set of pre-defined puzzles. A set of predefined puzzles may be provisioned in the UnEn during initial provisioning.

The network should ensure that the same puzzle is not being broadcast for too long of a time. The puzzle strength may be linked to the number of requests already handled/pending and network load. E.g., the complexity of the puzzle may increase to back off UnEn devices by introducing longer delays. Complexity may be linked to delay as well, e.g., the network equipment on board the satellite may want to introduce latency for approaching UnEN devices. Optionally, the network equipment on board the satellite may include the Shared Secret identifier which can assist the WTRU to choose the Shared Secret to derive the evidence. The WTRU may be provisioned with multiple Shared Secrets (or a set of Shared Secret parameters), each being identified by a Shared Secret identifier. As broadcasting of puzzles requires computing power on the WTRU side to resolve, this may be a deterrent factor for deployment with low power/less complex/ambient power IoT devices or WTRUs. The puzzle may have a validity time duration associated to it. The validity time duration may be broadcast as a parameter of the puzzle. In case the duration is expired, the UnEn may wait until the ENN broadcasts a new valid puzzle.

The WTRU may receive the broadcasted puzzle and solve it including the injection of the Shared Secret. Optionally the WTRU may also inject the WTRU identity and other pre-provisioned parameters. The WTRU may produce the evidence 1302. The injection of the pre-provisioned Shared Secret may be done in this step by e.g., hashing the intermediate puzzle evidence with the Shared Secret. The intent of the injection is to make the evidence obtained from the common puzzle (i.e., received in the broadcast) be distinguishable per WTRU.

The WTRU may send a Registration Request to the network equipment on board the satellite 1303. This message may include evidence obtained in the previous step, the WTRU identity, and the received puzzle corresponding to the one broadcasted. A puzzle index may be included in this step.

Upon receiving the Registration Request, the network equipment on board the satellite may look up the Shared Secret based on the WTRU identity 1304. Then, it may solve the puzzle, also including the injection of the Shared Secret and the optional injection of the WTRU identity and other pre-provisioned parameters, producing the expected evidence 1305. The WTRU identity may be used by the network equipment on board the satellite to get the shared secret, which was saved during the provisioning. Optionally, the network equipment on board of satellite may check whether the solved puzzle or its index returned corresponds to the broadcasted puzzle or its index. The injection of the pre-provisioned Shared Secret is done in this step by e.g., hashing the intermediate puzzle evidence with the Shared Secret. The intent of the injection is to make the evidence obtained from the common puzzle be distinguishable per WTRU. The puzzle is now solved on both sides and the evidence is available in the network equipment on board the satellite.

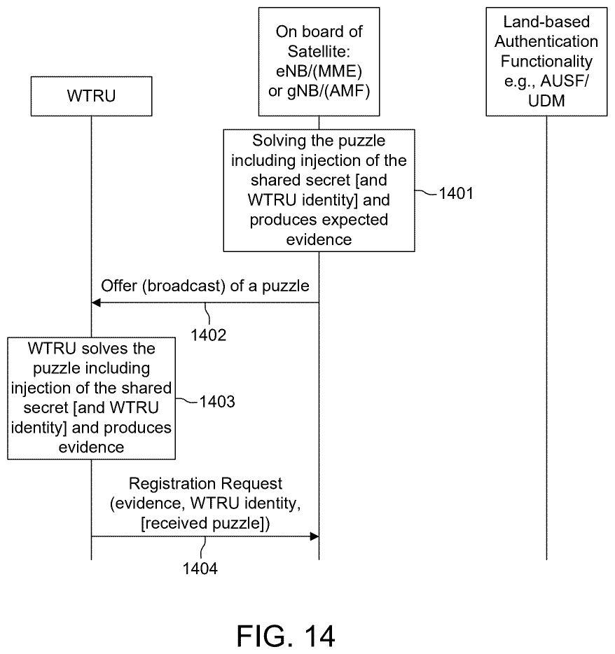

FIG. 14 shows an example of a (D)DOS remediation procedure in the context of satellite in S&F mode according to another embodiment.

In this embodiment, the network equipment on board the satellite may pre-solve the puzzle for a set of WTRUS in advance. For example, it may pre-solve the puzzle for all WTRUs that are pre-provisioned in its service area. As previously described, during pre-provisioning, the mapping between WTRU identity and Shared Secret may be established and saved by the network equipment on board the satellite. This mapping may then be used and the puzzle may be solved in advance and the evidence may be saved by the network equipment on board the satellite. This pre-solving of the puzzle may be done for a set of WTRUs or for all pre-provisioned WTRUs, as a method to further reduce the latency during WTRU registration. The information of all WTRUs of interest to the satellite are stored for future use.

The procedure in FIG. 14 may start after the network equipment on board the satellite completed the puzzle preparation/composition. The network equipment on board the satellite pre-solves the puzzle including the injection of the Shared Secret and optional WTRU identity and other pre-provisioned parameters and produces the expected evidence 1401. The injection of the pre-provisioned Shared Secret is done in this step by e.g., hashing the intermediate puzzle evidence with the Shared Secret. The expected evidence from this step is saved. The injection intends to make the evidence obtained from the common puzzle be distinguishable per WTRU. The solving of the puzzle is done for all WTRUs of interest.

The network equipment on board the satellite offers (e.g., broadcasts) the puzzle previously prepared 1402. Optionally, a puzzle index may be transmitted here. The network may ensure that the same puzzle is not being broadcast for too long of a time. The broadcast and puzzle strength may be linked with the number of requests already handled/pending and network load. E.g. the complexity of the puzzle may increase to back off UnEn devices to introduce longer delays. Complexity may be linked with how much back off (delay) the network equipment on board the satellite wants to introduce for approaching UnEn devices. Optionally the network equipment on board the satellite may include the Shared Secret key identifier which may assist the WTRU to choose the Shared Secret key to derive the evidence. The WTRU may be provisioned with multiple Shared Secret (or a set of Shared Secret parameters), each being identified by a Shared Secret identifier. As broadcasting of puzzles may require computer power on the WTRU side to resolve them, this may be a deterrent factor for the deployment with low power/less complex/ambient power IoT devices or WTRUs.

The WTRU may receive the broadcasted puzzle and solve the received puzzle including the injection of the Shared Secret and optional WTRU identity and other pre-provisioned parameters and produces evidence 1403. The injection of the pre-provisioned Shared Secret may be done in this step by e.g., hashing the intermediate puzzle evidence with the Shared Secret. The injection intends to make the evidence obtained from the common puzzle (i.e., received in the broadcast) distinguishable per WTRU.

The WTRU may send a Registration Request to the network equipment on board the satellite 1404. This message may include evidence obtained, the WTRU identity and the received puzzle corresponding to the one broadcasted. Optionally, a puzzle index may be sent. The puzzle is now solved on both sides and the evidence is available in the network equipment on board the satellite.

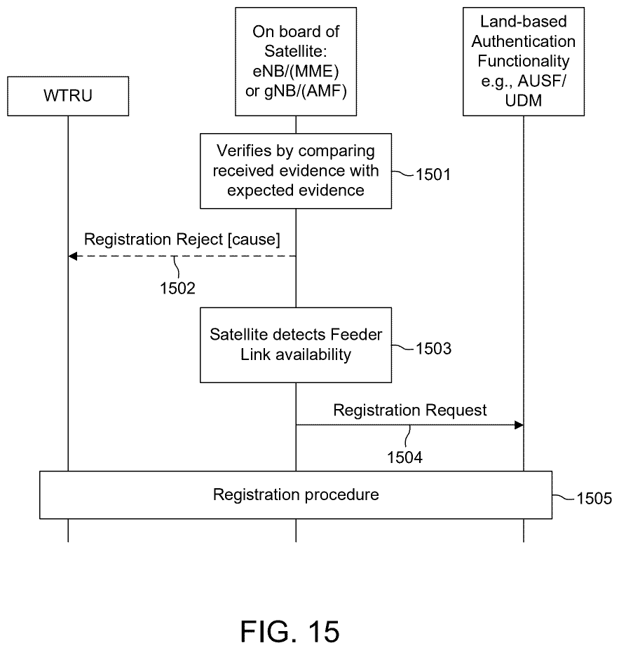

FIG. 15 illustrates an example call flow of the completion of a (D)DOS remediation procedure in the context of satellite in S&F mode.

The procedure in FIG. 15 initiates when the puzzle is solved on both sides and the evidence is available in the network equipment on board the satellite. The network equipment may verify the evidence received from the WTRU by comparing it with the evidence it produced locally 1501. If it is unable/fails to verify the evidence, the network equipment on board the satellite may send a Registration Reject to the WTRU 1502. In case of positive verification, the satellite may check the feeder link availability 1503. If/when the network equipment on board the satellite detects the feeder link is available, the network equipment on board the satellite may forward the Registration Request over the feeder link to the terrestrial network elements 1504 and the registration procedure is executed to completion 1505.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a wireless transmit and receive unit (WTRU) provisioned with a shared secret key, the method comprising:
receiving, from a network, broadcasted one or more parameters of a puzzle;
generating evidence based on solving the puzzle and injecting the shared secret key into the evidence while solving the puzzle;
sending, to the network, a registration request, wherein the registration request includes the generated evidence and a WTRU identity; and
receiving, from the network, a registration accept responsive to the registration request.

2. The method of claim 1, wherein the WTRU is further provisioned with the WTRU identity.

3. The method of claim 1, wherein the WTRU is further provisioned with a plurality of puzzles, wherein each puzzle comprises one or more parameters of the puzzle, and the one or more parameters of the puzzle include a puzzle index.

4. The method of claim 1, wherein the broadcasted one or more parameters of a puzzle include a puzzle index.

5. The method of claim 1, wherein the registration request further comprises the broadcasted one or more parameters of a puzzle.

6. The method of claim 1, wherein the network is a non-terrestrial network (NTN).

7. The method of claim 1, wherein the broadcasted one or more parameters of a puzzle are received from network equipment on board a satellite.

8. The method of claim 7, wherein the network equipment on board a satellite comprises an eNB or a gNB.

9. The method of claim 7, wherein the network equipment on board a satellite comprises a mobility management entity (MME) or an access and mobility management function (AMF).

10. A wireless transmit and receive unit (WTRU), the WTRU provisioned with a shared secret key, the WTRU comprising:
at least one transceiver and at least one processor, wherein:
the at least one transceiver and at least one processor are configured to receive, from a network, broadcasted one or more parameters of a puzzle;
the at least one transceiver and at least one processor are configured to generate evidence based on solving the puzzle and injecting the shared secret key into the evidence while solving the puzzle;
the at least one transceiver and at least one processor are configured to send, to the network, a registration request, wherein the registration request includes the generated evidence and a WTRU identity; and
the at least one transceiver and at least one processor are configured to receive, from the network, a registration accept responsive to the registration request.

11. The WTRU of claim 10, wherein the WTRU is further provisioned with the WTRU identity.

12. The WTRU of claim 10, wherein the WTRU is further provisioned with a plurality of puzzles, wherein each puzzle comprises one or more parameters of the puzzle, and the one or more parameters of the puzzle include a puzzle index.

13. The WTRU of claim 10, wherein the broadcasted one or more parameters of a puzzle include a puzzle index.

14. The WTRU of claim 10, wherein the registration request further comprises the broadcasted one or more parameters of a puzzle.

15. The WTRU of claim 10, wherein the network is a non-terrestrial network (NTN).

16. The WTRU of claim 10, wherein the broadcasted one or more parameters of a puzzle are received from network equipment on board a satellite.

17. The WTRU of claim 16, wherein the network equipment on board a satellite comprises an eNB or a gNB.

18. The WTRU of claim 16, wherein the network equipment on board a satellite comprises a mobility management entity (MME) or an access and mobility management function (AMF).
